(19) United States
(12) Patent Application Publication
(10) Pub. No.: US 2006/0140289 A1
(43) Pub. Date: Jun. 29, 2006

(54) Method and apparatus for providing an efficient pilot scheme for channel estimation

(76) Inventors: Giridhar D. Mandyam, San Diego, CA (US); Balaji Raghothaman, San Diego, CA (US); Roy Thomas Derryberry, Plano, TX (US)

Correspondence Address: DITTHAVONG & CARLSON, P.C.;Suite A, 10507 Braddock Road, Fairfax, VA, 22032, US

(21) Appl. No.: 11/023,287

(22) Filed: Dec. 27, 2004

(51) Int. Cl. H04K 1/10; H04B 1/707

(52) U.S. Cl. 375/260; 375/141

(57) ABSTRACT

An approach for utilizing a pilot scheme in a spread spectrum communication system (e.g., Multi Carrier Code Division Multiple Access (MC-CDMA)) is provided. A communications link includes a sub-bands and a single pilot channel that is designated for the sub-bands for channel estimation. Pilot symbols transmitted over the single pilot channel are used to determine a first channel estimate associated with a first one of the sub-bands, and a second channel estimate corresponding to a second one of the sub-bands is derived from the first channel estimate.

### FIELD OF THE INVENTION

The present invention relates to communications, and more particularly, to providing a pilot scheme for channel estimation.

### BACKGROUND OF THE INVENTION

Radio communication systems, such as cellular systems (e.g., Code Division Multiple Access (CDMA) network), provide users with the convenience of mobility along with a rich set of services and features. This convenience has spawned significant adoption by an ever growing number of consumers as an accepted mode of communication for business and personal uses. As a result, cellular service providers are continually challenged to enhance their networks and services as well as increase their customer base. These objectives place a premium on efficient management of network capacity.

Channel estimation plays a role critical in coherent CDMA communications for accurate replication of transmitted signals at the receiver. Unfortunately, conventional techniques for providing channel estimates can impose unnecessary overhead cost with respect to network capacity, consuming network resources that could have been allocated to user transmissions.

Therefore, there is a need for an approach to efficiently performing channel estimation, while minimizing overhead.

### SUMMARY OF THE INVENTION

These and other needs are addressed by the present invention, in which an approach is presented for providing a pilot scheme for channel estimation.

According to one aspect of an embodiment of the present invention, a method of communicating over a spread spectrum system is disclosed. The method includes establishing a communications link over the spread spectrum system. The communications link includes a plurality of sub-bands and a single pilot channel. The method also includes designating the single pilot channel for the sub-bands, wherein data transmitted over the single pilot channel is used to determine a first channel estimate associated with a first one of the sub-bands, and a second channel estimate corresponding to a second one of the sub-bands is derived from the first channel estimate.

According to another aspect of an embodiment of the present invention, a method of communicating over a spread spectrum system is disclosed. The method includes generating a pilot symbol used for channel estimation of a communications link within the spread spectrum system. The communications link includes a plurality of sub-bands. Additionally, the method includes transmitting the pilot symbol over a pilot channel associated with the sub-bands. The pilot symbol is used to determine a first channel estimate associated with a first one of the sub-bands, and a second channel estimate corresponding to a second one of the sub-bands is derived from the first channel estimate.

According to another aspect of an embodiment of the present invention, an apparatus for communicating over a spread spectrum system is disclosed. The apparatus includes a processor configured to generate a pilot symbol used for channel estimation of a communications link within the spread spectrum system. The communications link includes a plurality of sub-bands, wherein the pilot symbol is transmitted over a pilot channel associated with the sub-bands. The pilot symbol is used to determine a first channel estimate associated with a first one of the sub-bands, and a second channel estimate corresponding to a second one of the sub-bands is derived from the first channel estimate.

According to another aspect of an embodiment of the present invention, a method of communicating over a spread spectrum system is disclosed. The method includes receiving a pilot symbol from a pilot channel common to a plurality of sub-bands of a communications link within the spread spectrum system. The method also includes determining a first channel estimate associated with a first one of the sub-bands. Further, the method includes determining a second channel estimate corresponding to a second one of the sub-bands from the first channel estimate.

According to yet another aspect of an embodiment of the present invention, an apparatus for communicating over a spread spectrum system is disclosed. The apparatus includes means for receiving a pilot symbol from a pilot channel common to a plurality of sub-bands of a communications link within the spread spectrum system; and means for determining a first channel estimate associated with a first one of the sub-bands. The apparatus also includes means for determining a second channel estimate corresponding to a second one of the sub-bands from the first channel estimate.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-1D are diagrams of spread spectrum transmission systems, each capable of providing an optimized pilot scheme, according to various embodiments of the present invention

FIG. 2 is a diagram of a pilot scheme utilizing multiple pilot channels for a corresponding number of sub-bands;

FIG. 3 is a flowchart of a process for providing a single pilot channel for multiple sub-bands, according to an embodiment of the present invention;

FIG. 4 is a flowchart of a process for determining channel estimates of sub-bands without corresponding pilot channels under the pilot scheme of FIG. 3, according to an embodiment of the present invention;

FIG. 5 is a diagram of the components of the single antenna MC-CDMA system of FIG. 1A;

FIG. 6 is a diagram showing the pilot modulation and demultiplexing operation of the system of FIG. 5;

FIG. 7 is a diagram of an exemplary MC-CDMA transmitter;

FIG. 8 is a diagram of an exemplary MC-CDMA receiver;

FIG. 9 is a graph showing that channel realizations for adjacent carriers are practically identical under a multiple pilot channel scheme; and

FIG. 10 is a diagram of hardware that can be used to implement an embodiment of the present invention.

### DESCRIPTION OF THE PREFERRED EMBODIMENT

An apparatus, method, and software for providing a pilot scheme for channel estimation are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

According to one embodiment of the present invention, an approach is provided for efficiently utilizing a pilot scheme in a spread spectrum system, such as Multi Carrier Code Division Multiple Access (MC-CDMA), in support of channel estimation. A single pilot channel is designated for a group of sub-bands within a communications link (e.g., forward link) of a radio communication system (e.g., cellular network). In an exemplary embodiment, the single pilot channel corresponds to a “center” sub-band for determining the channel estimate of this center sub-band. The channel estimates of the other sub-bands within the group of sub-bands are derived from respective phase shifts of the determined channel estimate. This approach advantageously enhances system capacity by avoiding use of multiple pilot channels, which consume precious network bandwidth.

Although various embodiments of the present invention are described with respect to code division communication systems, it is recognized that the present invention can be practiced in any spread spectrum communication systems, as well as other radio communication systems. For instance, several paths for the evolution of deployed Code Division Multiple Access (CDMA) networks are contemplated. One path is to use the 3× Multi Carrier CDMA (MC-CDMA), as further described later.

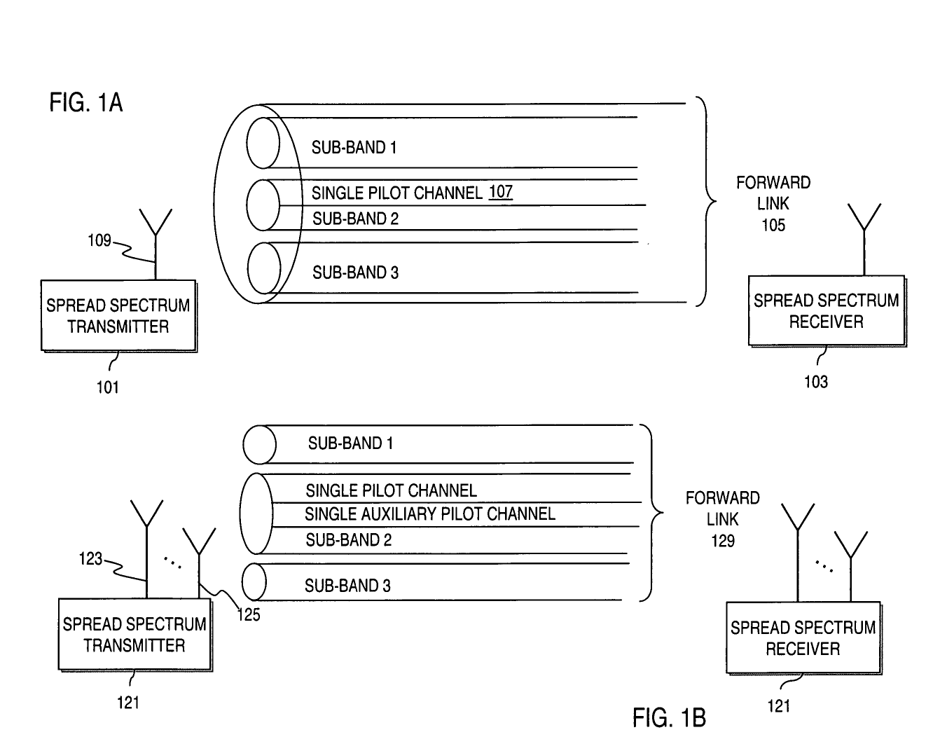

FIGS. 1A-1D are diagrams of spread spectrum transmission systems, each capable of providing an optimized pilot scheme, according to various embodiments of the present invention. The spread spectrum systems of FIGS. 1A-1D can support Third Generation (3G) services as defined by the International Telecommunications Union (ITU) for International Mobile Telecommunications 2000 (IMT-2000). By way of example, a spread spectrum transmitter 101, which can be resident in a base station, communicates in a MC-CDMA system with a receiver 103 (of a mobile station) using a communications link 105, which includes multiple sub-bands 1-3. MC-CDMA provides spreading in the frequency domain and can be viewed in numerous, equivalent forms. One perspective is that MC-CDMA can be represented as certain forms of Direct Sequence CDMA, whereby a Fourier Transform is performed after spreading or the code sequence is a Fourier Transform of a Walsh Hadamard sequence. MC-CDMA is also considered a form of orthogonal frequency division multiplexing (OFDM), whereby an orthogonal matrix operation is performed on the user bits. That is, user data is spread over a subset of the sub-carriers of a standard OFDM system. Compared to standard direct-spread CDMA (DS-CDMA) systems, MC-CDMA exhibits higher peak throughput and potential diversity gains.

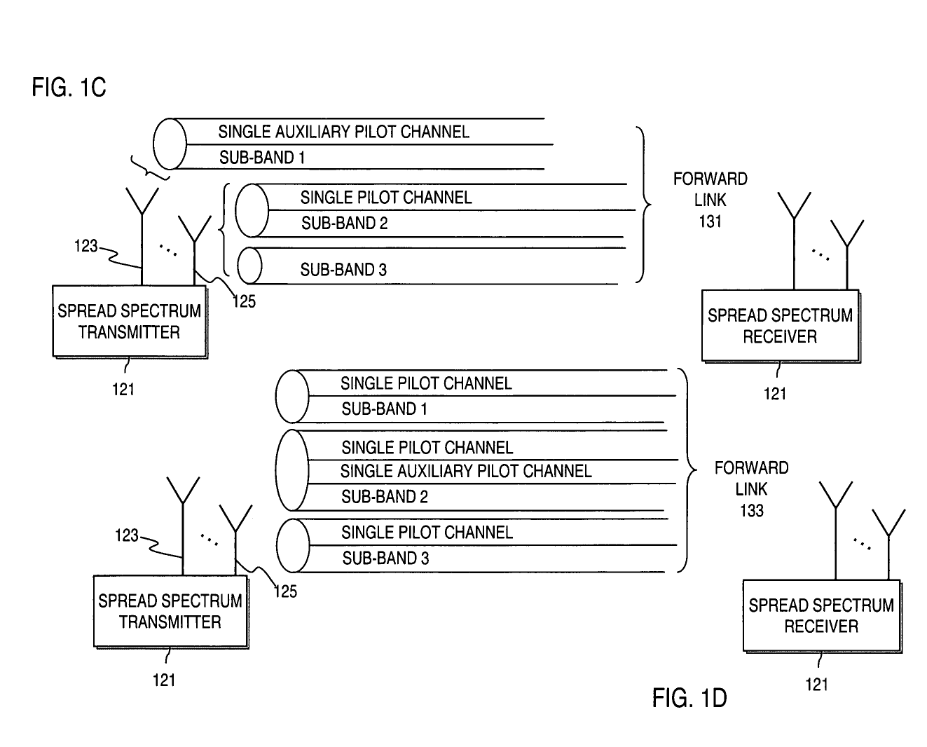

In one embodiment of the present invention, the link 105 is a forward link; that is, in the direction of the transmitter 101 to the receiver 103. As mentioned, channel estimation is critical in coherent CDMA communications and is accomplished via a pilot channel. In an exemplary embodiment, the pilot channel is a code-multiplexed channel used by the transmitter 101 primarily for channel quality estimation of the forward link 105. Under this scenario, the transmitter 101 transmits pilot symbols over a single pilot channel 107, advantageously minimizing overhead; the pilot channel 107 is associated with the center sub-band—i.e., sub-band 2. The pilot channel 107 is effectively common to all the sub-bands 1-3. Such an approach contrasts with the multiple pilot channel scheme of FIG. 2. The example of FIG. 1A shows a single antenna system, whereby the transmitter 101 utilizes a single antenna 109 and the receiver 103 employ one antenna 111.

In general, MC-CDMA systems have received significant attention as a technology for supporting advance cellular systems (e.g., so-called 3.5-G extensions to existing 3G systems). This is due to the fact that such systems retain the multi-user capacity advantages of CDMA while incorporating the aspects of orthogonal frequency division multiplexed (OFDM) systems to enhance peak throughput. Such MC-CDMA systems can readily support overlay deployment and backwards-compatibility. For instance, in order to facilitate overlay deployments, the multicarrier version of cdma2000 deploys a pilot channel over each possible sub-carrier (denoted as “3×MC-CDMA”), as shown in FIG. 2.

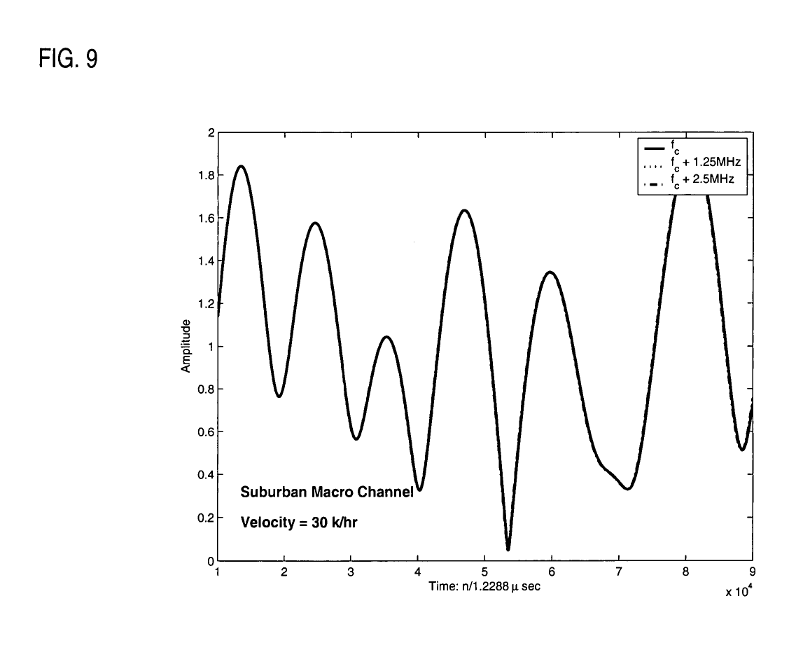

FIG. 2 is a diagram of a pilot scheme utilizing multiple pilot channels for a corresponding number of sub-bands. That is, a forward link 200, under this multiple pilot channel scheme, requires a pilot channel for each sub-band, thereby requiring greater overhead vis-à-vis the single pilot channel approach. In this case, sub-bands, 1-3, utilize pilot channels, 1-3, respectively. This scheme is further detailed in The Third Generation Partnership Project 2 (3GPP2). 3GPP2 C.S0002-A: Physical Layer Standard for cdma2000 Spread Spectrum Systems, Release A. Jun. 9, 2000. This multiple pilot channel scheme can potentially introduce a large amount of overhead to the MC-CDMA system, particularly given the fact that in the forward link each pilot channel must be deployed with sufficient power to provide adequate coverage within each cell. Typically, a pilot channel occupies 20% to 25% of the total base station output power, as it has to be received over the entire range of coverage of a base station. Thus, under the pilot scheme of FIG. 2, deployment of 3 pilot channels over 3 sub-bands in a 3× MC-CDMA system can reduce system capacity unnecessarily. It is recognized that the 3× MC-CDMA system defined for cdma2000 does not provide sufficient frequency diversity to necessitate the need for three pilot channels (as further explained with respect to FIG. 9).

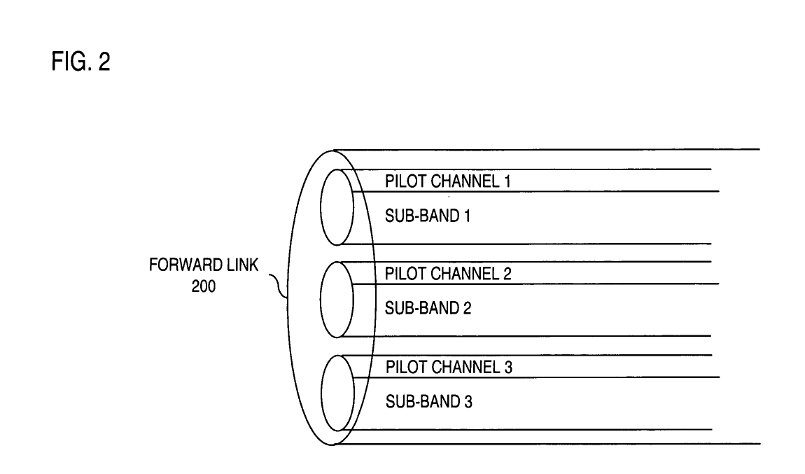

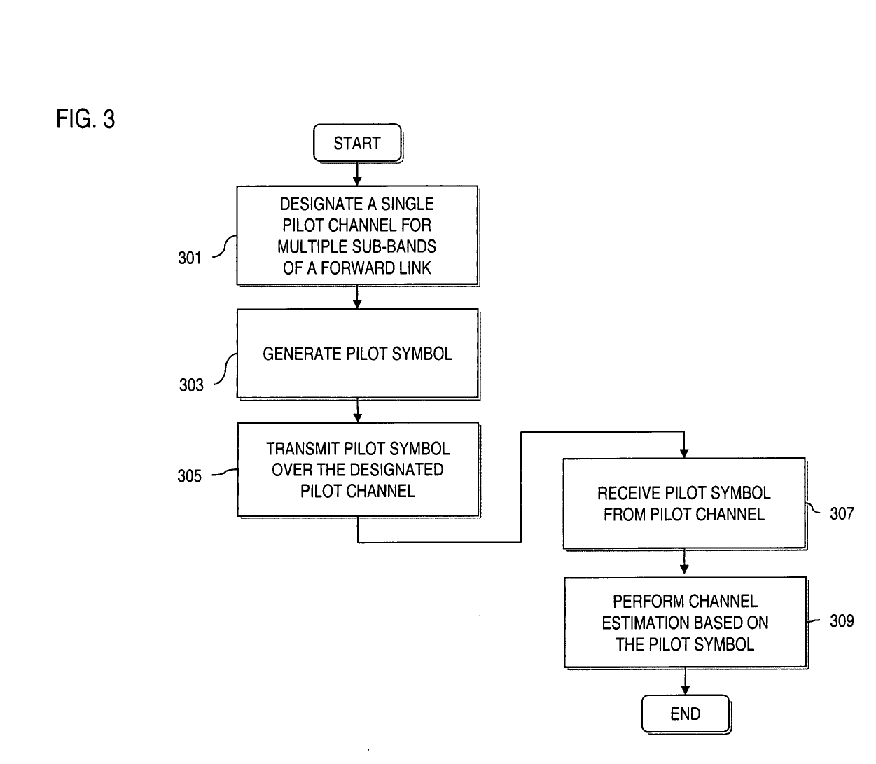

By contrast, the single pilot channel scheme of FIG. 1A can be used to determine the channel estimate of all the sub-bands 1-3, even if this pilot channel 107 appears on only one sub-band (i.e., sub-band 2). Based on reception of the pilot channel 107, channel estimates for sub-bands over which there are no pilot channels can be reconstructed based on applying a phase shift to the channel estimate corresponding to the sub-band with the associated pilot channel. This phase shift can be estimated by the relative frequency of a given sub-band along with the relative delay of a given multipath for which the channel estimate is being formulated. The above approach is more fully described below with respect to FIGS. 3 and 4. It is contemplated that this approach can be applied to multi-antenna transmission systems as well, as shown in FIGS. 1B-1D.

As seen in FIG. 1B, a spread spectrum transmitter 121 includes multiple antennas 123, 125 and operates in a CDMA system (e.g., cdma2000 1× system) employing space-time coded approaches on forward link transmission to communicate with a receiver 127. These approaches require antenna-specific pilot channels to be deployed (“auxiliary pilots”) over a forward link 129. It is noted that even if a cellular network cannot be deployed without a primary pilot channel available on each sub-band of a 3× MC-CDMA system so as to ensure backwards-compatibility for cdma2000 1× terminals, only one auxiliary pilot channel deployment on one sub-band can be implemented for multi-antenna transmission such that the other antenna channel estimates for the other two sub-bands.

Under the scenario of FIG. 1B, the antenna 123 transmits over sub-bands 1 and 3 without a pilot channel. The antenna 125 utilizes a single primary plot and a single auxiliary pilot channel. However, the operation of the channel estimation of the antenna 125 can exploit the approach of a single pilot channel for multiple sub-bands. Namely, the single pilot channel, although associated with sub-band 2, can be used to derive the channel estimates for the other sub-bands 1 and 3. Such deployment results in a savings of one less auxiliary pilot channel, in that only two pilot channels are used to support accurate reception of all three sub-bands.

In another exemplary embodiment (FIG. 1C), the antennas 123 and 125 are configured to transmit using different sub-bands. For instance, the antenna 123 transmits over sub-band 1, while the antenna 125 utilizes sub-bands 2 and 3. In this forward link 131, a single auxiliary pilot channel used with sub-band 1, and a single primary pilot channel is utilized in sub-band 2; sub-band 3 is without any pilot channel.

In yet another embodiment, the system of FIG. 1D provides for backward compatibility with cdma2000 1× terminals. A forward link 133 utilizes a primary pilot channel for each sub-band; e.g., sub-bands 1 and 3. Additionally, the sub-band 2 utilizes a single auxiliary pilot channel.

The operation of the single pilot channel scheme, according to an embodiment of the present invention, is now explained with respect to the system of FIG. 1A.

FIG. 3 is a flowchart of a process for providing a single pilot channel for multiple sub-bands, according to an embodiment of the present invention. In step 301, the single pilot channel 107 is designated for multiple sub-bands (e.g., sub-bands 1-3) for the forward link 105. The transmitter 101 generates one or more pilot symbols for transmission over the pilot channel 107 (steps 303 and 305). At the receiver 103, the pilot symbol is obtained from the pilot channel 107, as in step 307. The receiver 103, per step 309, then performs channel estimation based on the pilot information. This process of channel estimation is further detailed below in FIG. 4.

FIG. 4 is a flowchart of a process for determining channel estimates of sub-bands without corresponding pilot channels under the pilot scheme of FIG. 3, according to an embodiment of the present invention. In step 401, the receiver 103 tunes to the pilot channel 107. According to one embodiment of the present invention, the pilot channel 107 is assigned to a center sub-band, which in this example is sub-band 2. At the receiver 103, channel estimates are derived for each multipath for the sub-band over which the pilot channel is deployed (this is known both at the transmitter 101 and the receiver 103), i.e. the “pilot sub-band”. Thus, in step 403, the channel estimates are determined for the center sub-band.

For the other sub-bands, their individual channel estimates for each multipath are determined (or derived) from the original channel estimates from the transmitted pilot adjusted by a phase shift (per steps 405 and 407). The phase shift, in an exemplary embodiment, is defined by the sub-band transmission frequency relative to the pilot sub-band frequency and the relative multipath delay.

To better appreciate the above single pilot channel scheme, it is demonstrated in the next several figures that only one pilot channel is sufficient for 3× MC-CDMA, and as a result, potential capacity savings are possible in such a system by not deploying the other two superfluous pilot channels.

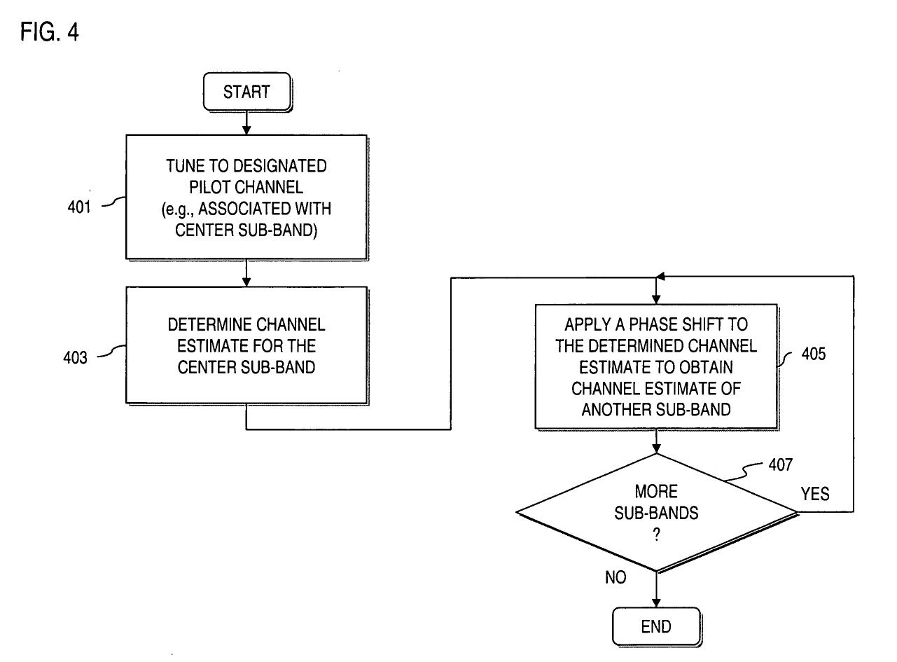

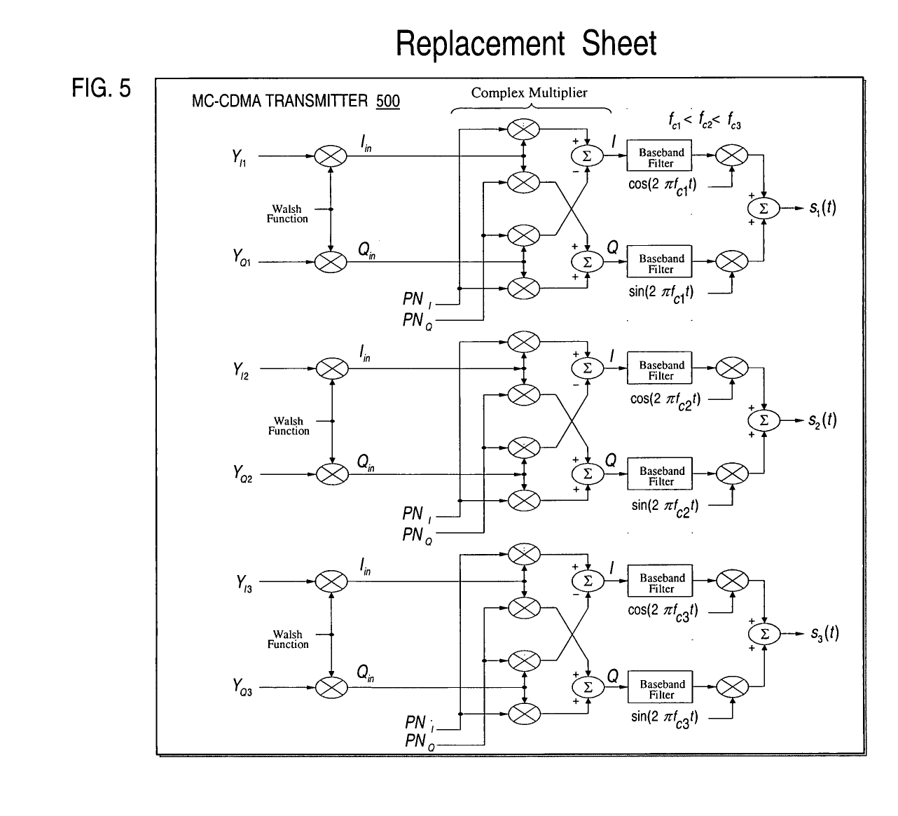

FIG. 5 is a diagram of the components of the single antenna MC-CDMA system of FIG. 1A. For the purposes of explanation, the MC-CDMA system of FIG. 1A is a 3× MC-CDMA system, whose spreading operation on the forward link 105 is performed according to a MC-CDMA transmitter 500. With reference to this figure, each of the individual carriers (denoted as f_{c1}, f_{c2}, and f_{c3}) for all intents and purposes operates, for example, as a cdma2000 1× carrier. The carrier separation is 1.25 MHz between each neighboring sub-carrier. However, an individual user may receive information over all three sub-carriers simultaneously; accordingly, the user's data is demultiplexed into the streams Y_{Il} and Y_{Ql}, 0<l≦3. Moreover, a pilot channel is employed to assist in channel demodulation, pilot modulation and demultiplexing, as shown in FIG. 6.

FIG. 6 is a diagram showing the pilot modulation and demultiplexing operation of the system of FIG. 5. As shown, information pilot channel information is modulated through a signal point mapping logic 601, whose output is shaped by a channel gain module 603. Demultiplexer 605 are used to generate the data streams, Y_{Il} and Y_{Ql}, 0<l≦3.

As discussed, it is recognized that in terms of channel estimation of the sub-carriers f_{c1}, f_{c2}, and f_{c3} that one pilot channel is sufficient, whereby the use of additional pilot channels does not provide any additional information at the receiver 103.

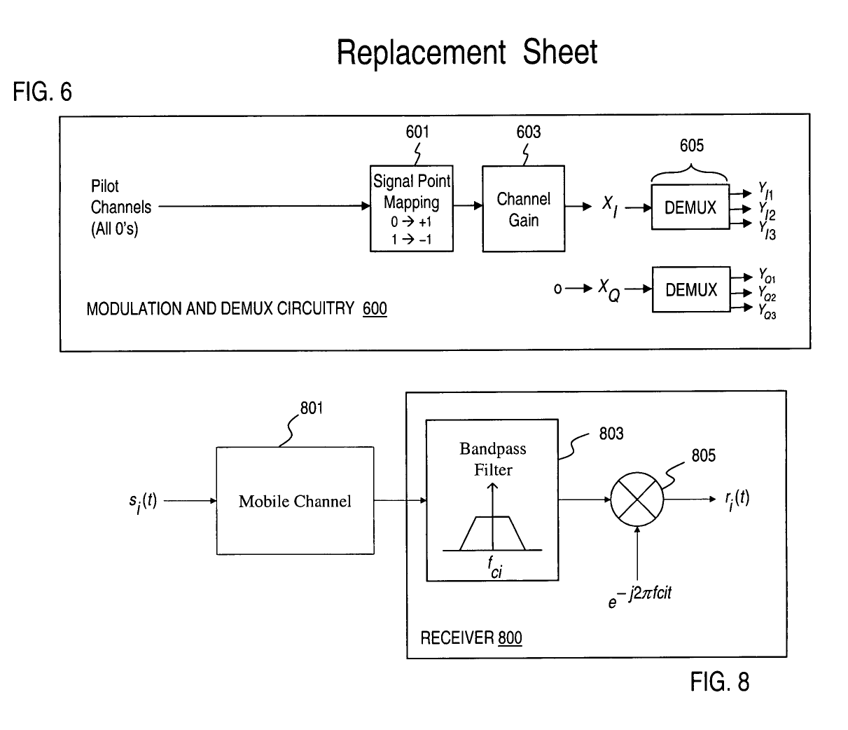

FIG. 7 is a diagram of an exemplary MC-CDMA transmitter. For the purposes of explanation, a MC-CDMA transmitter 700 that is configured to operate on a single user's data (index j) is described. User j's data, denoted by the pair of scalars Yₗⱼ and Y_{Qj}, is replicated and demultiplexed into K parallel streams by a demultiplexer. Each of the K parallel data streams is modulated with a length K spreading code. After modulation with the spreading code, each parallel data stream is modulated with one of a set of K orthogonal sub-carriers. Specifically, in each of the K parallel data streams, the repeated user data symbol is modulated with one chip of a user-specific spreading sequence dⱼ. Thereafter, each of the parallel streams may undergo baseband pulse shaping before modulation by one of K orthogonal sub-carriers. The pulse shaping provides for better isolation between sub-carriers. If the chip duration for the spreading sequence is denoted by T_{c}, then the transmission bandwidth of each sub-carrier after pulse shaping can be represented as (1+β)/T_{c}, where 0<β≦1.

In Shiro Kondo and Laurence B. Milstein. “Performance of Multicarrier DS CDMA Systems.” IEEE Transactions on Communications. Vol. 44. No. 2. February 1996. pp. 238-246, the authors presented an analysis of multicarrier CDMA systems that are suitable for overlays over direct-spread CDMA systems. In their analysis, they assumed that each sub-band exhibited no frequency selectivity. This suggests that if the maximum delay spread of the wireless transmission channel is represented by Tₘ, then the coherence bandwidth (approximately 1/Tₘ) would follow the relationship:

$$\frac{1}{{T}_{m}} > \frac{( 1 + β )}{{T}_{c}} . \qquad ( 1 )$$

In a flat-fading channel, the above criterion, Eq. (1) can be met. However, in a multicarrier system derived from several direct-spread overlaid systems, this criterion is almost impossible to meet under typical cellular transmission conditions. In fact, the coherence bandwidth normally seen in cellular channels is normally much smaller than the cdma2000 1× bandwidth of 1.25 MHz.

In the cdma2000 multicarrier system, the pilot channel deployment over each of the 3 sub-bands appears identical to a cdma2000 1× pilot deployment. With respect to systems of FIGS. 5 and 6, the signal over any given sub-carrier may be represented as follows:

$${s}_{i} ( t ) = {ⅇ}^{j 2 π {f}_{ci} t} {\sum }_{n = - ∞}^{∞} PN ( n ) h ( t - {nT}_{c} ) , 1 \leq i \leq 3 \qquad ( 2 )$$

In Eq. (2), PN(n) is the complex representation of PN₁ and PN_{Q} at chip index n and h(t) is the defined cdma2000 pulse shape. If this multicarrier, “pilot-only” signal is transmitted (using the same transmit antenna) through a multipath channel consisting of L paths, then the received baseband signal may be represented as follows:

$$r ( t ) = {\sum }_{l = 0}^{L - 1} {α}_{l} ( t ) {ⅇ}^{j {ϕ}_{l} ( t )} {\sum }_{i = 1}^{3} {s}_{i} ( t - {τ}_{l} ) . \qquad ( 3 )$$

The channel magnitude for path l at time t is given by α₁(t), the channel phase is given by φₗ(t), and the relative path delay by τₗ. Given the representation of sᵢ(t) in Eq. (2), r(t) may be written as follows:

$$r ( t ) = {\sum }_{l = 0}^{L - 1} {α}_{l} ( t ) {ⅇ}^{j {ϕ}_{l} ( t )} {\sum }_{i = 1}^{3} {ⅇ}^{j 2 π {f}_{ci} ( t - {τ}_{l} )} {\sum }_{n = - ∞}^{∞} PN ( n ) h ( t - {τ}_{l} - {nT}_{c} ) . \qquad ( 4 )$$

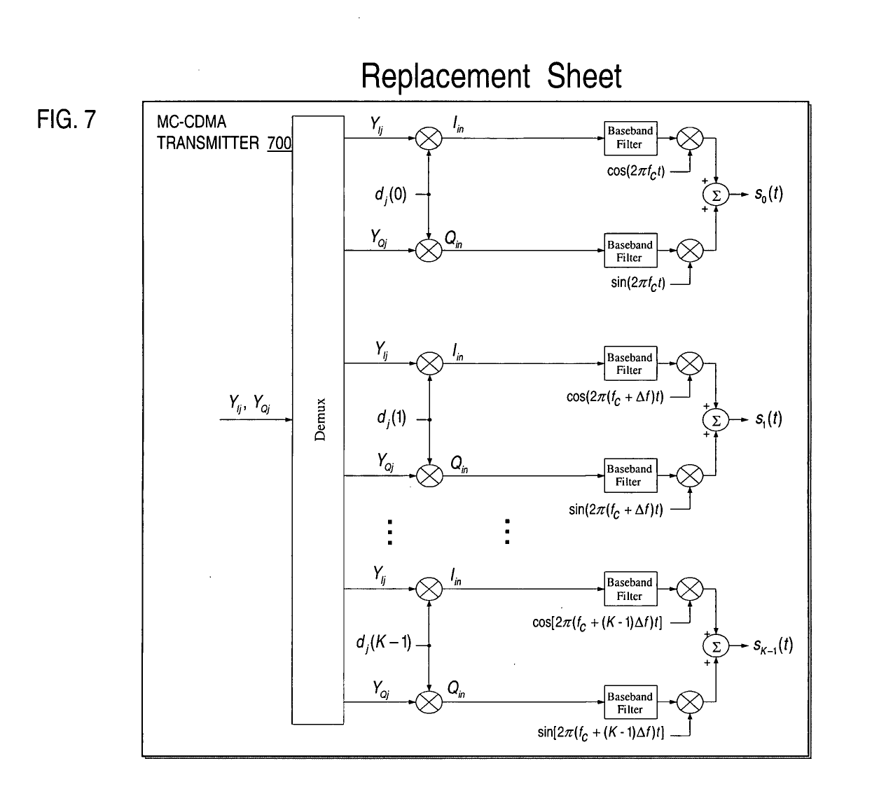

If it is assumed that the received signal r(t) is passed through a bandpass filter whose center frequency is f_{ci} and demodulated by the signal e^{-j2πfci}, (as shown in FIG. 8) then the resultant baseband signal is as follows:

$$r ( t ) = {\sum }_{l = 0}^{L - 1} {α}_{l} ( t ) {ⅇ}^{j {ϕ}_{l} ( t )} {ⅇ}^{j 2 π {f}_{ci} {τ}_{l}} {\sum }_{n = - ∞}^{∞} PN ( n ) m ( t - {τ}_{l} - {nT}_{c} ) \qquad ( 5 )$$

The above equation assumes that the channel coefficients for each of the sub-carriers will remain unchanged from the bandpass operation. Using a widely used model for generating fading channels, it is shown, per FIG. 9, that the difference between the channel coefficients in adjacent carriers is indeed negligible for carrier spacing of either 1.25 MHz or 2.5 MHz. This processing is depicted in FIG. 8.

FIG. 8 is a diagram of an exemplary MC-CDMA receiver. In this example a receiver 800 receives a signal, si(t), after transmission over a mobile channel 801. The receiver includes a bandpass filter 803 with a center frequency of f_{ci}, and a mixer 805 for mixing the filtered signal with e^{-j2πfci} for demodulation.

In Eq. (5), m(t) represents the effects of the receiver bandpass filter 803 convolved with the transmit pulse shape h(t) as seen at baseband. If it is assumed that the bandpass filter 803 is perfectly matched to the transmit pulse shaping waveform, and that perfect time synchronization is possible at the receiver 800, then the only difference between the received pilot channels on each of the sub-carriers for any given multipath l is a constant complex phase term dependent on f₁ and τ₁.

Since each sub-band carrier frequency is known at the receiver 800, and the channel impulse response (i.e., {αₗ, τₗ} for all l) can be constructed using just one of the sub-band pilot signals, the other two pilot signals do not provide additional information for channel estimation. Thus, if it is assumed that an estimated channel for each carrier is cᵢ(n), then the following relationship holds:

$$\frac{{c}_{i} ( n )}{{c}_{k} ( n )} = {ⅇ}^{- j 2 π ( {f}_{ci} - {f}_{ck} ) {τ}_{l}} . \qquad ( 6 )$$

It should be noted that this assertion is not valid when each sub-band is transmitted through its own dedicated transmission antenna. This stems from the fact that the channel impulse response seen on each sub-band cannot be assumed to be identical under such conditions, and therefore the relationship in Eq. (3) does not apply.

A number of simulations were performed in support of the recognition that use of additional pilot channels in the MC-CDMA system of FIG. 1A would be entirely unnecessary. Notably, these simulations were performed based on transmission of three pilot channels through three sub-carriers as described earlier. The sub-carriers were simulated at baseband, meaning that {f_{c1}, f_{c2}, f_{c3}}={0 MHz, 1.25 MHz, 2.5 MHz}. In the first simulation, the channel power profile was {0.6 0.2 0.2} with relative delays of 1 and 2 chips for the 2^{nd} and 3^{rd} multipaths, respectively. For each sub-carrier received, channel estimation was performed over each pilot signal using a 640 chip rectangular window. In this test, no fading or additive noise effects were simulated. The simulation was carried out at a maximum rate of 8 times the cdma2000 1× chipping rate of 1.2288 MHz. An 80,000-chip simulation yielded the results in Table 1.

TABLE 1

| | % Error Path 1 | % Error Path 2 | % Error Path 3 |
|---|---|---|---|
| f_{c1} = 0 Hz | 0.25 | 0.91 | 0.35 |
| f_{c2} = 1.25 MHz | 5.84 | 5.41 | 5.85 |
| f_{c3} = 2.5 MHz | 0.86 | 3.67 | 1.40 |

In Table 1, the estimated channel for each sub-carrier is compared to the actual channel coefficients. The phase shift mentioned earlier, which is based only on the sub-carrier frequency and the multipath lag, is not present with respect to the simulation, as the lags occur at multiples of T_{c}, meaning that the phase shift is approximately a multiple of 2π. This indicates that if f_{c1} is 0 MHz, then the relative phase shift of the channel estimates for f_{c2} at the 1 chip and 2 chips lags are 0.11 and 0.22 radians, and f_{c3} are 0.22 and 0.44 radians. Therefore, this phase shift was accounted for in determining the percentage error results in Table 1.

As observed in Table 1, the best performance corresponds to the sub-band transmitted at baseband. The other two sub-bands exhibit higher error rates due to imperfect bandpass filtering (in fact, the middle sub-band f_{c2} suffered the most from sideband leakage from both f_{c1} and f_{c3}). In addition, the weaker paths show less accurate channel estimates than the stronger path due the relatively higher levels of multipath interference. It is noted that the channel estimates derived from one pilot (in this case the pilot associated with f_{c1}) tracked the actual channel coefficients closely. Therefore, this pilot can be used along with the relevant phase shifts to create appropriate channel estimates for the other two frequencies.

In another test, the same channel model was examined under fading conditions, assuming a mobile velocity of 10 km/hr and transmission frequencies such that f_{c1}=1.9 GHz. The results of an 80,000-chip simulation are provided in Table 2.

TABLE 2

| | % Error Path 1 | % Error Path 2 | % Error Path 3 |
|---|---|---|---|
| f_{c1} = 0 Hz | 0.87 | 1.28 | 0.76 |
| f_{c2} = 1.25 MHz | 6.60 | 3.19 | 4.21 |
| f_{c3} = 2.5 MHz | 1.63 | 5.15 | 2.86 |

Again, the channel estimates associated with a single pilot (at f_{c1}) tracked most closely to the channel coefficients.

To further substantiate the single pilot channel approach, spatial channel modeling was performed.

FIG. 9 is a graph showing that channel realizations for adjacent carriers are practically identical under a multiple pilot channel scheme. A standard method of modeling the wireless channel was employed to accurately quantify differences between channel coefficients in adjacent 1× bands. The spatial channel model is described in both the 3GPP2 and 3GPP forums (3GPP-3GPP2 SCM AdHoc Group. “Spatial Channel Model Text Description”, April 2003). The channel model uses distributions for delay spread, azimuth spread, etc. that are derived from field-testing. The channel is characterized as having 6 paths with delays given by a randomized delay spread. These 6 paths, however, can be resolved to a different number of paths based on the resolution of the observation. Each of these 6 paths is modeled as being created by a scatterer, which generates a certain angular distribution. This distribution is approximated as a sum of 20 pencil rays (known as sub-paths or rays) generated at various angles within the angular spread. Thus, the channel coefficients based on the spatial channel model can be represented by the following equation:

$${h}_{u , s , n} ( t ) = \sqrt{\frac{{P}_{n} {σ}_{SF}}{M}} {\sum }_{m = 1}^{M} ( \begin{matrix}\sqrt{{G}_{BS} ( {θ}_{n , m , AoD} )} \overbrace{exp ( j \{ {kd}_{s} sin ( {θ}_{n , m , AoD} ) + {Φ}_{n , m} ] )}^{A} \times \\ \sqrt{{G}_{MS} ( {θ}_{n , m , AoA} )} \overbrace{exp ( {jkd}_{u} sin ( {θ}_{n , m , AoA} ) )}^{B} \times \\ \overbrace{exp ( jk ‖ v ‖ cos ( {θ}_{n , m , AoA} - {θ}_{v} ) t )}^{C}\end{matrix} ) , \qquad ( 7 )$$

, where u, s denote the index of the antenna at the transmitter 101 (e.g., base station) and the receiver 103 (e.g., mobile station) respectively, n is the path index, m is the ray index, G(θ) is the directional gain of the antenna, v is the velocity and θᵥ is the direction of travel of the mobile station. The carrier frequency affects the wave number term

$$k = 2 π \frac{{f}_{c}}{c}$$

in Eq. (7). The terms dₛ, dᵤ denote the distances from the reference antenna to the antennas under consideration in the base station and mobile station respectively.

First, for the sake of simplicity, the Single Input Single Output (SISO) case is considered, with one antenna at the base station and mobile station respectively, where the terms A and B disappear in Eq. (7). FIG. 9 shows a comparison of the channel amplitude for a realization of the SCM model for 3 adjacent carrier frequencies. The suburban macro environment with a mobile velocity of 30 km/hr was simulated. It can be seen from the figure that the channel realizations for adjacent carriers are practically identical, supporting the assumption in Eq.(5).

When multiple antennas are involved at the base station and/or the mobile station, and antennas other than the reference antenna are considered (dₛ, dᵤ>0), the terms A and B in Eq. (7) are non-zero, but still do not affect the outcome of the comparison.

Simulation results for the 3× MC-CDMA system as well as analysis of industry-accepted spatial channel models demonstrate that there is not much benefit for deployment of 3 pilot channels for the purposes of channel estimation when a single transmit antenna is used on the forward link. Consequently, the system of FIG. 1A utilizes a single pilot channel deployed over a single sub-band. This single pilot channel scheme can be extended to the case of multi-antenna transmission (e.g., space-time coding or multi-input/multi-output) where antenna-specific pilot channels are required.

The single pilot channel scheme as detailed above can be executed through a variety of hardware and/or software configurations.

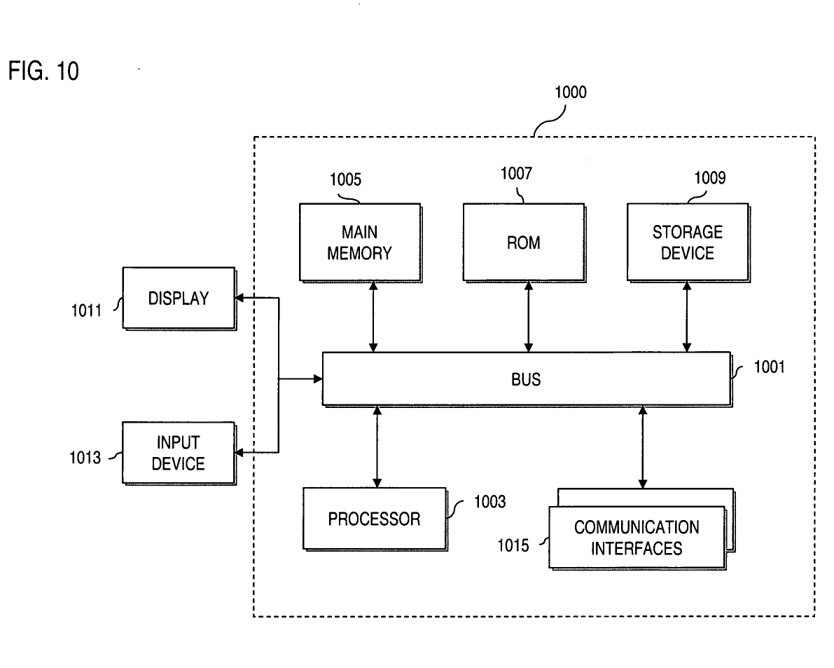

FIG. 10 illustrates exemplary hardware upon which an embodiment according to the present invention can be implemented. A computing system 1000 includes a bus 1001 or other communication mechanism for communicating information and a processor 1003 coupled to the bus 1001 for processing information. The computing system 1000 also includes main memory 1005, such as a random access memory (RAM) or other dynamic storage device, coupled to the bus 1001 for storing information and instructions to be executed by the processor 1003. Main memory 1005 can also be used for storing temporary variables or other intermediate information during execution of instructions by the processor 1003. The computing system 1000 may further include a read only memory (ROM) 1007 or other static storage device coupled to the bus 1001 for storing static information and instructions for the processor 1003. A storage device 1009, such as a magnetic disk or optical disk, is coupled to the bus 1001 for persistently storing information and instructions.

The computing system 1000 may be coupled via the bus 1001 to a display 1011, such as a liquid crystal display, or active matrix display, for displaying information to a user. An input device 1013, such as a keyboard including alphanumeric and other keys, may be coupled to the bus 1001 for communicating information and command selections to the processor 1003. The input device 1013 can include a cursor control, such as a mouse, a trackball, or cursor direction keys, for communicating direction information and command selections to the processor 1003 and for controlling cursor movement on the display 1011.

According to one embodiment of the invention, the processes of FIGS. 3 and 4 can be provided by the computing system 1000 in response to the processor 1003 executing an arrangement of instructions contained in main memory 1005. Such instructions can be read into main memory 1005 from another computer-readable medium, such as the storage device 1009. Execution of the arrangement of instructions contained in main memory 1005 causes the processor 1003 to perform the process steps described herein. One or more processors in a multi-processing arrangement may also be employed to execute the instructions contained in main memory 1005. In alternative embodiments, hard-wired circuitry may be used in place of or in combination with software instructions to implement the embodiment of the present invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the present invention are not limited to any specific combination of hardware circuitry and software.

The computing system 1000 also includes at least one communication interface 1015 coupled to bus 1001. The communication interface 1015 provides a two-way data communication coupling to a network link (not shown). The communication interface 1015 sends and receives electrical, electromagnetic, or optical signals that carry digital data streams representing various types of information. Further, the communication interface 1015 can include peripheral interface devices, such as a Universal Serial Bus (USB) interface, a PCMCIA (Personal Computer Memory Card International Association) interface, etc.

The processor 1003 may execute the transmitted code while being received and/or store the code in the storage device 1009, or other non-volatile storage for later execution. In this manner, the computing system 1000 may obtain application code in the form of a carrier wave.

The term “computer-readable medium” as used herein refers to any medium that participates in providing instructions to the processor 1003 for execution. Such a medium may take many forms, including but not limited to non-volatile media, volatile media, and transmission media. Non-volatile media include, for example, optical or magnetic disks, such as the storage device 1009. Volatile media include dynamic memory, such as main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the present invention has been described in connection with a number of embodiments and implementations, the present invention is not so limited but covers various obvious modifications and equivalent arrangements, which fall within the purview of the appended claims.

What is claimed is:

1. A method of communicating over a spread spectrum system, the method comprising:
establishing a communications link over the spread spectrum system, the communications link including a plurality of sub-bands and a single pilot channel; and
designating the single pilot channel for the sub-bands,
wherein data transmitted over the single pilot channel is used to determine a first channel estimate associated with a first one of the sub-bands, and a second channel estimate corresponding to a second one of the sub-bands is derived from the first channel estimate.

2. A method according to claim 1, further comprising:
applying a phase shift to the first channel estimate to derive the second channel estimate.

3. A method according to claim 1, wherein the single pilot channel is associated with one of the sub-bands, the one sub-band being a center sub-band.

4. A method according to claim 1, wherein user data is transmitted over the communications link using one or more transmission antennas.

5. A method according to claim 1, wherein the spread spectrum system is a Multi Carrier Code Division Multiple Access (MC-CDMA) cellular network.

6. A method according to claim 1, wherein the single pilot channel is a code-multiplexed channel.

7. A method of communicating over a spread spectrum system, the method comprising:
generating a pilot symbol used for channel estimation of a communications link within the spread spectrum system, the communications link including a plurality of sub-bands; and
transmitting the pilot symbol over a pilot channel associated with the sub-bands,
wherein the pilot symbol is used to determine a first channel estimate associated with a first one of the sub-bands, and a second channel estimate corresponding to a second one of the sub-bands is derived from the first channel estimate.

8. A method according to claim 7, wherein the second channel estimate is derived by applying a phase shift to the first channel estimate.

9. A method according to claim 7, wherein the pilot channel is associated with one of the sub-bands, the one sub-band being a center sub-band.

10. A method according to claim 7, further comprising:
transmitting user data over the communications link using one or more antennas.

11. A method according to claim 7, wherein the spread spectrum system is a Multi Carrier Code Division Multiple Access (MC-CDMA) cellular network.

12. A method according to claim 7, wherein the pilot channel is a code-multiplexed channel.

13. A computer-readable medium bearing instructions for communicating over a spread spectrum system, said instructions, being arranged, upon execution, to cause one or more processors to perform the method of claim 7.

14. An apparatus for communicating over a spread spectrum system, the apparatus comprising:
a processor configured to generate a pilot symbol used for channel estimation of a communications link within the spread spectrum system, the communications link including a plurality of sub-bands,
wherein the pilot symbol is transmitted over a pilot channel associated with the sub-bands, the pilot symbol being used to determine a first channel estimate associated with a first one of the sub-bands, and a second channel estimate corresponding to a second one of the sub-bands is derived from the first channel estimate.

15. An apparatus according to claim 14, wherein the second channel estimate is derived by applying a phase shift to the first channel estimate.

16. An apparatus according to claim 14, wherein the pilot channel is associated with one of the sub-bands, the one sub-band being a center sub-band.

17. An apparatus according to claim 14, further comprising:
an antenna system configured to transmit user data over the communications link using one or more antennas.

18. An apparatus according to claim 14, wherein the spread spectrum system is a Multi Carrier Code Division Multiple Access (MC-CDMA) cellular network.

19. An apparatus according to claim 14, wherein the pilot channel is a code-multiplexed channel.

20. A method of communicating over a spread spectrum system, the method comprising:
receiving a pilot symbol from a pilot channel common to a plurality of sub-bands of a communications link within the spread spectrum system;
determining a first channel estimate associated with a first one of the sub-bands; and
determining a second channel estimate corresponding to a second one of the sub-bands from the first channel estimate.

21. A method according to claim 20, further comprising:
applying a phase shift to the first channel estimate to determine the second channel estimate.

22. A method according to claim 20, wherein the pilot channel is associated with one of the sub-bands, the one sub-band being a center sub-band.

23. A method according to claim 20, wherein the spread spectrum system is a Multi Carrier Code Division Multiple Access (MC-CDMA) cellular network.

24. A method according to claim 20, wherein the pilot channel is a code-multiplexed channel.

25. A computer-readable medium bearing instructions for communicating over a spread spectrum system, said instructions, being arranged, upon execution, to cause one or more processors to perform the method of claim 20.

26. An apparatus for communicating over a spread spectrum system, the apparatus comprising:
means for receiving a pilot symbol from a pilot channel common to a plurality of sub-bands of a communications link within the spread spectrum system;
means for determining a first channel estimate associated with a first one of the sub-bands; and
means for determining a second channel estimate corresponding to a second one of the sub-bands from the first channel estimate.

27. An apparatus according to claim 26, further comprising:
means for applying a phase shift to the first channel estimate to determine the second channel estimate.
